(19) United States
(12) Patent Application Publication
(10) Pub. No.: US 2009/0107933 A1
(43) Pub. Date: Apr. 30, 2009

(54) BICYCLE RACK

(75) Inventors: William H. Porter, Saugatuck, MI (US); Christopher J. Kreple, Holland, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: PorterCorp

(21) Appl. No.: 12/013,010

(22) Filed: Jan. 11, 2008

Related U.S. Application Data
(60) Provisional application No. 60/982,583, filed on Oct. 25, 2007.

(51) Int. Cl. B62H 3/00

(52) U.S. Cl. 211/20

(57) ABSTRACT

A bicycle rack includes a plurality of loops attached to the post, each loop being attached at top and bottom locations to a support and defining a space with an adjacent one of the loops for receiving a bicycle wheel. Each loop extends radially from the support at about 24 degrees angular spacing, with each loop's top located about 18 inches above the ground, and a bottom about 10 inches from the ground. Each loop includes horizontal linear top and bottom segments and a horizontal linear bottom segment, which combines with the angular spacing and vertical dimensions to provide easy reach for a bicycle rider locking/unlocking their bicycle from the rack. The support for the loops can be a post, a wall or the like.

This application claims benefit under 35 U.S.C. § 119(e) of provisional application Ser. No. 60/982,583, filed Oct. 25, 2007, entitled BICYCLE RACK, the entire contents of which are incorporated herein by reference.

### BACKGROUND

The present invention relates to bicycle racks, and more particularly to a bicycle rack for dense temporary storage of bicycles, including an ability to easily lock individual bicycles in place.

Bicycle racks are often used to support bicycles in a stored standing position, such as at parks, meeting locations, work, and other destinations where people ride bicycles. However, many known bicycle racks suffer from a poor appearance, poor density of bicycles being stored, poor durability and high cost. Also, as the storage density of a rack is increased, the ability to lock or unlock one's bicycle decreases due to the interference of adjacent bicycles. It is noted that bicycles are often stolen when the front (or rear) tire/rim is locked to a bicycle rack, with the thief taking everything except the front (or rear) tire/rim, since the missing tire/rim can be easily replaced. An additional problem is that densely stored bicycles tend to rub against, fall over on, and/or hang up on each other during placement and removal of the bicycle, resulting in damage to both of the adjacent bicycles.

### SUMMARY OF THE PRESENT INVENTION

In one aspect of the present invention, a bicycle rack includes a post and a plurality of loops attached at top and bottom locations to the post and defines a space with an adjacent one of the loops for receiving a bicycle wheel. Each loop defines a plane and extends radially from the post for at least about 90 degrees around the post. By this arrangement, an optimal dense storage of bicycles is provided, while still providing easy engagement of the bicycle with the rack, and while also allowing good access for locking and unlocking the bicycle from the rack.

In another aspect of the present invention, a bicycle rack includes a support, and a plurality of loops. The plurality of loops is attached to the support at top and bottom locations, with adjacent pairs of the loops defining a space for receiving and engaging a bicycle wheel. Each loop defines a plane that extends at an angle of between about 20 to 30 degrees with the adjacent loop in the pair.

In a narrower form, the angle noted about is about 24 degrees, and the loops are at least about 17 inches high and at least about 9 inches deep (horizontally), so that the space is configured to frictionally engage a bike tire without rubbing the bike's frame, and further so that a bike lock can be easily engaged and disengaged with the loop and bike frame by a user.

The present appearance is also believed to be novel, ornamental, and unobvious.

An object of the present invention is to provide a bicycle rack and lock system that is easy to use and that facilitates locking the bicycle's frame to the rack.

An object of the present invention is to provide a rack that holds bicycles in an upright position by wedging the tires only.

An object of the present invention is to provide a second wedge plane or bar giving more lateral support.

An object of the present invention is to provide a loop extending from the base frame/support that allows a lock to be used to secure the bicycle to the frame.

An object of the present invention is to provide a number of similar wedge units attached to the same bicycle rack frame in a manner that allows for a maximum number of bicycles to be racked in a small space.

An object of the present invention is to support a plurality of wedges on a solid frame in a manner that allows them to be readily used and yet modified as needed for the site. Notably, the loops (i.e., wedge-forming structural members) can be positioned in a circular manner for 360 degrees, 180 degrees, or 90 degrees, and can be positioned linearly or in a curvilinear fashion

These and other aspects, objects, and features of the present invention will be understood and appreciated by those skilled in the art upon studying the following specification, claims, and appended drawings.

### BRIEF DESCRIPTION OF DRAWINGS

FIGS. 1-4 are top perspective, bottom perspective, side, and top views of the bicycle rack alone.

FIGS. 5-7 are perspective, side, and top views of a bicycle rack embodying the present invention.

FIGS. 8-10 are perspective, side, and top views of a bicycle rack embodying the present invention.

FIG. 11 is a perspective view similar to FIG. 8, but showing a U-rod-shaped bicycle lock retaining the bicycle to the rack, and FIG. 12 is an enlarged view of the lock in FIG. 11.

FIG. 13 is a fragmentary perspective view showing a modified bicycle rack.

### DETAILED DESCRIPTION OF PREFERRED EMBODIMENTS

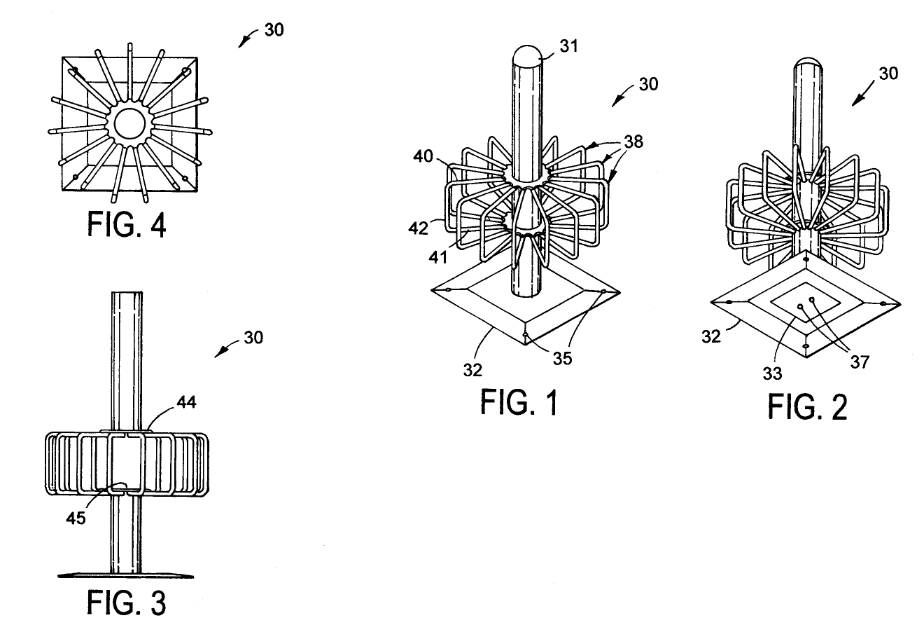

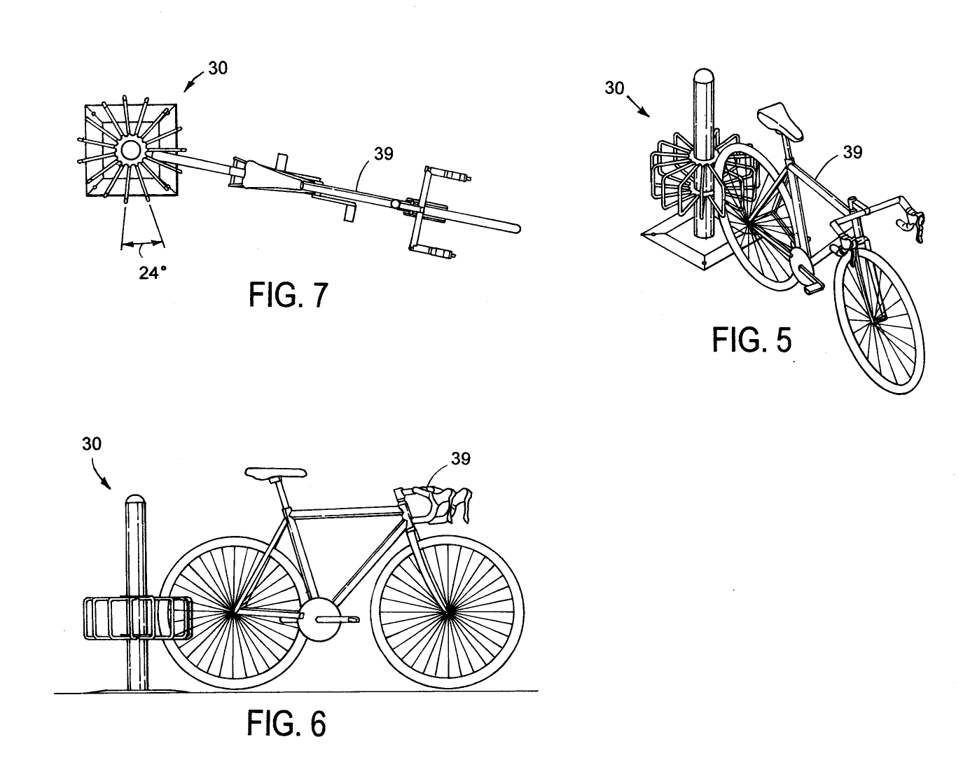

A bicycle rack 30 (FIGS. 1-2) includes a post 31 (also called a “support”) anchored to the ground using a ground-anchored base plate 32 and a post-anchoring flange plate 33, the base plate 32 being secured to the ground 34 using corner anchor bolts 35, and the flange plate 33 securing the post 31 to the base plate 32 using bolts 37. It is noted that the post 31 can be anchored to the ground in a number of different ways, such as by fasteners and plates as illustrated, or by welding to existing building structure, by attaching to existing foundation structure, or by placing the post in a foundation/concrete.

A plurality of “square” loops 38 (also called “structural members”) are attached to sides of the post 31, each loop 38 defining a vertical plane and extending radially preferably at about 20-30 degree circumferential spacing (or more preferably at about 24 degree circumferential spacing. Each loop 38 is U-shaped, and includes a horizontal linear top leg 40 (or “segment”) attached at a top location about 17 inches up the post 31 and extending about 9 inches from a center of the post 31, a horizontal linear bottom leg 41 (or “segment”) attached at a bottom location about 10 inches up the post, and a vertical linear leg 42 that extends between ends of the top and bottom legs 40, 41. The loops 38 are located preferably extending from the post 31 for at least about 90 degrees and preferably up to 360 degrees around the post 31, preferably at about 20 to 30 degrees apart from each other and more preferably at about 24 degrees apart. This allows the loops 38 to frictionally engage a tire on a bicycle 39 and hold the bicycle 39 upright without rubbing against the bicycle's frame. Notably, the square shape of the loops 38 (especially the upper/outer corner) combine with the angular spacing and vertical dimensions to provide an aperture (i.e., the inside of the loop 38) that is an easy reach for a bicycle rider locking/unlocking their bicycle 39 from the rack 30. Also, the bicycles 39 are each angularly positioned “away” from an adjacent bicycle, which further facilitates a bicycle rider locking/unlocking their bicycle 39 by inherently providing room for the rider. Still further, the upper/outer corner of the loops 38 is at a height (and is a sufficient distance from the post 31) making it easier to reach with a bike lock and chain/cord than some bike racks.

A stabilizer plate 44 is attached to the post 31 and to an inner end of the top leg 40, and a second stabilizer plate 45 is attached to the post 31 and to an inner end of the bottom leg 41. The stabilizer plates 44 and 45 further stabilize the assembly and help to provide a clean neat appearance.

The present invention includes a method of racking bicycles in upright positions by wedging their tire (front or rear) between two metal bars or plates. Additional support is also added with an upper or lower bar in the same plane. The wedge bars or planes are attached to an upright column or frame supported on an upright column. The wedge action works surprisingly and unexpectedly well, especially around a column when at angles of 24 degrees. This angle of 24 degrees provides for 15 bicycles around a column if all held by their rear wheels. It spaces the bicycles 39 as close as possible together while maintaining sufficient spacing to minimize adjacent bicycles from rubbing against and/or falling against each other. Also, the angle of 24 degrees is able to universally accept most (or all) different sizes of bicycles. Holding bicycles by their rear wheels is preferred because more bicycles can fit densely together as noted. However, this arrangement also positions the bicycle's frame closest to the loop. It is preferable to lock the bicycle's frame to the bicycle rack (and not just lock the bicycle's tire/rim to the bicycle rack) in order to minimize the risk of theft . . . because bicycle thieves often will steal the bicycle frame and leave the locked tire/rim.

Additional modified bicycle racks are disclosed below. In the modified racks, similar or identical features are identified using the same numbers but with the letter “A,” “B,” etc. This is done to reduce redundant discussion.

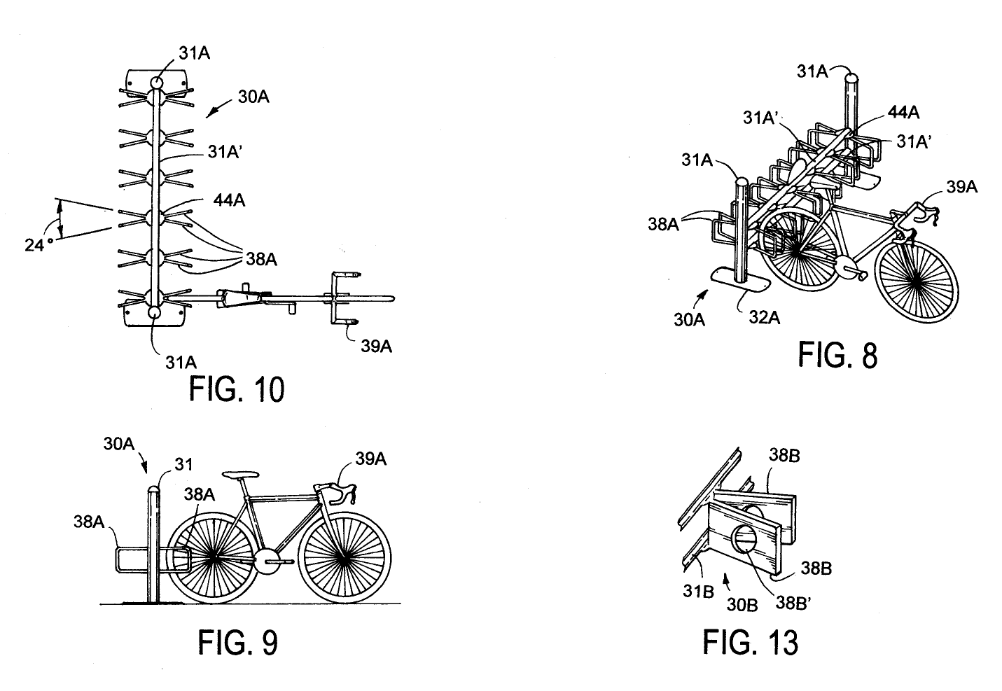

A linear version of the bicycle rack 30A (FIGS. 8-10) includes a support 31A comprising a pair of posts (31) and horizontal beams 31A′ extended therebetween. The beams 31A′ are sufficient in strength to structurally support the plurality of “square” loops 38A. Loops 38A are sufficiently similar to loops 38 in height, size, and shape, such that they do not require further discussion, other than to note that adjacent loops 38A each define a vertical plane and extend preferably at about 20-30 degrees with an adjacent one of the loops 38A (or more preferably at about 24 degree circumferential spacing). Notably, the square shape of the loops 38A (especially the upper/outer corner) combine with the angular spacing of pairs of the loops 38A and vertical dimensions to provide easy reach for a bicycle rider locking/unlocking their bicycle 39A from the rack 30A. Also, the bicycles 39A are each angularly positioned “away” from an adjacent bicycle, which further facilitates a bicycle rider locking/unlocking their bicycle by inherently providing room for the rider. Still further, the upper/outer corner of the loops 38A is at a height (and is a sufficient distance from the post) making it easier to reach with a bike lock and chain/cord than some bike racks.

A stabilizer plate 44A is attached to the beams 31A′ at each loop 38A to stabilize the assembly and to help provide a clean neat appearance.

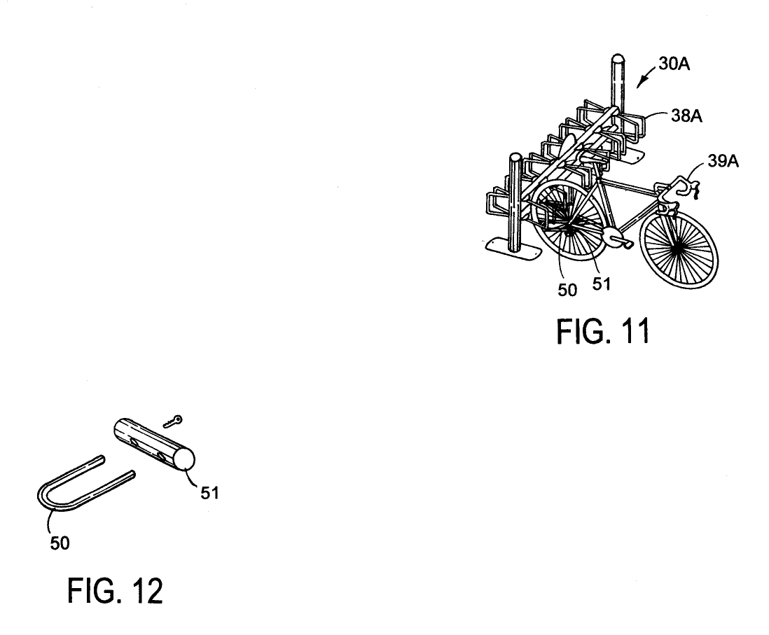

FIGS. 11-12 show how the present racks allow for easier use of a U-rod-shaped bicycle lock with solid non-bendable U rod 50 and lock 51, both due to room around the bicycle 39A when engaged with the rack 30A and also due to a high/outward location of the loops 38A.

FIG. 13 illustrates a bicycle rack 30B where the loops 38B are formed by apertured panels (such as sheet steel) (i.e., “apertured structural members”), with an aperture 38B′ in the sheets allowing pass-through of the bicycle lock for locking engagement.

At least the following features are believed to be novel, useful, and unobvious over known art: 1) wedging the tires only, 2) a second wedge plane or bar giving more lateral support, 3) a loop extending from the base frame/support that allows a lock to be used to secure the bicycle to the frame, 4) a number of similar wedge units being attached to the same bicycle rack frame in a manner that allows for a maximum number of bicycles to be racked in a small space, and 5) supporting the wedges on a solid frame in a manner that allows them to be readily used and yet modified as need for the site. Notably, the loops (i.e., wedge-forming structural members) can be positioned in a circular manner for 360 degrees, 180 degrees, or 90 degrees, and can be positioned linearly or in a curvilinear fashion.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A bicycle rack comprising:
a post; and
a plurality of loops attached at top and bottom locations to the post and defining a space with an adjacent one of the loops for receiving a bicycle wheel, each loop defining a plane and extending radially from the post for at least about 90 degrees around the post.

2. The rack defined in claim 1, wherein the angle between each adjacent loop is between about 15 to 33 degrees.

3. The rack defined in claim 1, wherein the angle between each adjacent loop is between about 20 to 30 degrees.

4. The rack defined in claim 1, wherein the angle between each adjacent loop is about 24 degrees.

5. The rack defined in claim 1, wherein the top of each loop is located at least about 12 inches above a ground surface and the bottom of each loop is located at most about 12 inches above the ground surface, thus providing access to the loop for locking a bicycle.

6. The rack defined in claim 5, wherein the top of each loop is located at least about 17 inches above the ground surface.

7. The rack defined in claim 6, wherein the bottom of each loop is located about 10 inches above the ground surface.

8. The rack defined in claim 1, wherein each loop includes a horizontal linear top segment, a horizontal linear bottom segment, and a vertical linear segment extending between ends of the top and bottom segments.

9. A bicycle rack comprising:
a support; and
a plurality of loops attached to the support at top and bottom locations, with adjacent pairs of the loops defining a space for receiving and engaging a bicycle wheel, each loop defining a plane that extends at an angle of between about 20 to 30 degrees with the adjacent loop in the pair.

10. The rack defined in claim 9, wherein the angle between each pair of loops is about 24 degrees.

11. The rack defined in claim 9, wherein the top of each loop is located at least about 12 inches above a ground surface and the bottom of each loop is located at most about 12 inches above the ground surface, thus providing access to the loop for locking a bicycle.

12. The rack defined in claim 11, wherein the top of each loop is located at least about 17 inches above the ground surface.

13. The rack defined in claim 1, wherein each loop includes a horizontal linear top segment, a horizontal linear bottom segment, and a vertical linear segment extending between ends of the top and bottom segments.

14. A method of racking and storing a bicycle in an upright position, the bicycle including a frame and tires, comprising steps of:
providing a bicycle rack including a support and adjacent structural members defining a wedge-shaped space configured to frictionally engage one of the tires to hold the bicycle in an upright position without frictionally engaging the bicycle's frame, one of the support and adjacent structural members defining an aperture;
providing a bicycle lock; and
locking the bicycle frame to the bicycle rack by passing the lock through the aperture and the bicycle frame and securing the lock.
